(19) United States
(12) Patent Application Publication
(10) Pub. No.: US 2013/0076666 A1
(43) Pub. Date: Mar. 28, 2013

(54) TOUCH INPUT DEVICE AND METHOD

(71) Applicant: ZHEN-WEI XU, Shenzhen City (CN)

(72) Inventor: ZHEN-WEI XU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/523,947

(22) Filed: Jun. 15, 2012

(30) Foreign Application Priority Data
Sep. 27, 2011 (CN) 201110293925.6

(51) Int. Cl. G06F 3/041

(52) U.S. Cl. 345/173

(57) ABSTRACT

A touch input device includes a first storage module, a second storage module, a touch input unit, a first detecting unit, a second detecting unit, a processing module and a housing. When one or both of the first and the second detecting units detect a touch of a user on one or two corners of the housing, the processing module will make one or two soft keyboards be shown on the touch input unit according to position information stored in the first and the second storage modules. The user can use single hand or both hands to input a command. The disclosure further provides a touch input method.

### BACKGROUND

1. Technical Field

The present disclosure relates to a touch input device and a touch input method, and particularly to a touch input device and a touch input method for starting a soft keyboard to input on a touch screen.

2. Description of Related Art

Inputting commands by a soft keyboard on a touch screen is a primary input method of some touch input device, such as a tablet computer and a smart phone with a touch screen. However, the user should trigger a specific key first to show the soft keyboard when he/she would like to perform an input action. It is inconvenient for the user. In addition, it is also difficult to perform the input action when the user holds the tablet computer with both hands. Moreover, the conventional soft keyboard occupies almost half of the screen so that much content will be obstructed by the soft keyboard and cannot be seen by the user.

What is needed, therefore, is a touch input device capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a touch input device of the present disclosure.

FIG. 2 is an appearance diagram of the touch input device in FIG. 1.

FIG. 3 is an enlarged diagram of Part III in FIG. 2.

FIG. 4 is a flowchart of an embodiment of a touch input method of the present disclosure.

### DETAILED DESCRIPTION

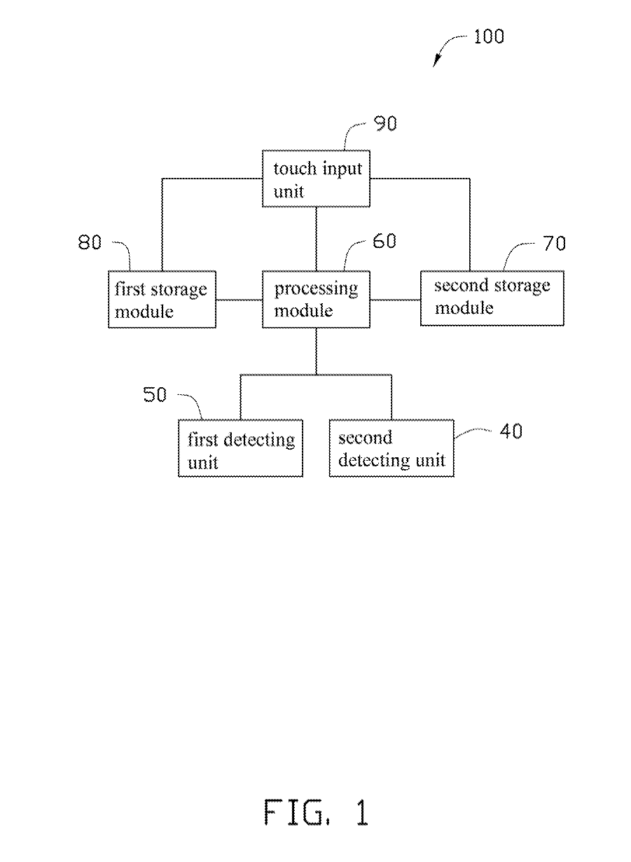

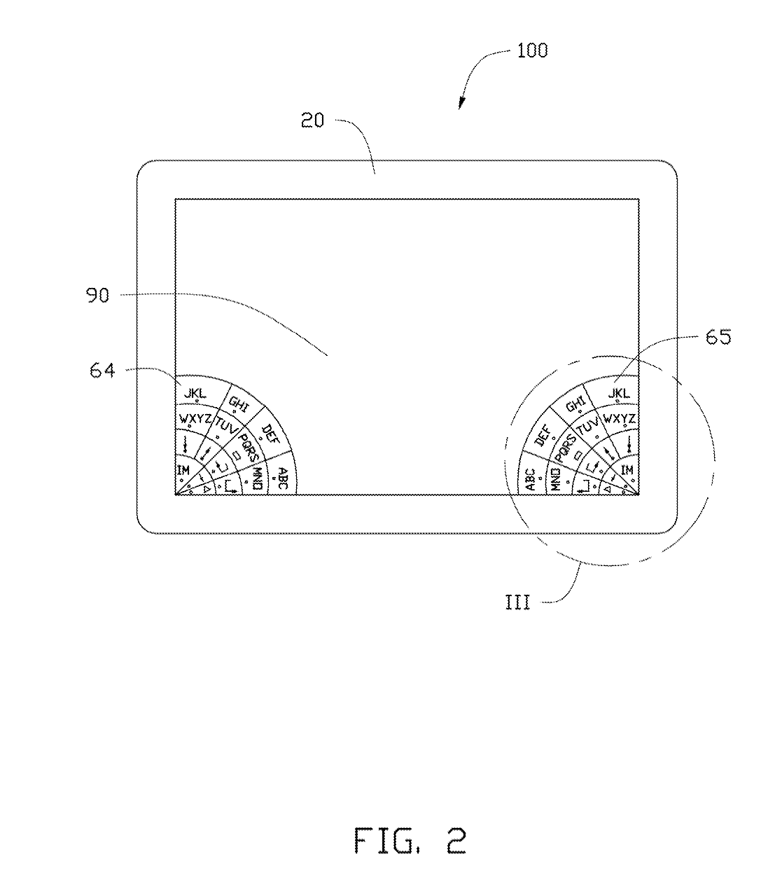

FIG. 1 and FIG. 2 illustrate an embodiment of a touch input device 100. The touch input device 100 includes a first storage module 80, a second storage module 70, a touch input unit 90, a first detecting unit 50, a second detecting unit 40, a processing module 60 and a housing 20.

The first storage module 80 stores a first keyboard 64 and first position information of the first keyboard 64 shown on the touch input unit 90. For example, the first keyboard 64 can be shown on a lower left corner of the touch input unit 90 according to the first position information. In the embodiment, the first keyboard 64 is a soft keyboard.

The second storage module 70 stores a second keyboard 65 and second position information of the second keyboard 65 shown on the touch input unit 90. For example, the second keyboard 65 can be shown on a lower right corner of the touch input unit 90 according to the second position information. In the embodiment, the second keyboard 65 is a soft keyboard. In order to use the first and the second keyboards 64 and 65 easily, the first and the second keyboards 64 and 65 are preset to show on two adjacent corners of the touch input unit 90, such as a lower left corner and a lower right corner or an upper left corner and an upper left corner.

The touch input unit 90 shows the first and the second keyboards 64 and 65 and receives an input command triggered from the first keyboard 64 or the second keyboard 65, wherein the input command is triggered by an action, such as a press and a touch, on a key of the first keyboard 64 or the second keyboard 65.

Since the shape of the touch input unit 90 is approximately a rectangle, the housing surrounding the touch input unit 90 includes four corners. The first detecting unit 50 is installed on a first corner of the housing 20 near the touch input unit 90 and the second detecting unit 40 is installed on a second corner of the housing 20 near the touch input unit 90. For example, the first corner is a lower left corner of the housing 20 and the second corner is a lower right corner of the housing 20. The first detecting unit 50 transmits a first detecting signal when detecting a touch on the first corner while the second detecting unit 40 transmits a second detecting signal when detecting a touch on the second corner. In other embodiments, the housing 20 includes at least two corners since the touch input device 100 includes two detecting unit 50 and 40 corresponding to two keyboards 64 and 65 for the two hands operation. In the embodiment, both of the first and the second detecting units 50 and 40 are proximity sensors, such as infrared sensors.

The processing module 60 is connected with the touch input 90, the first storage module 80, the second storage module 70, the first detecting unit 50 and the second detecting unit 40. If the processing module 60 receives the first detecting signal, the processing module 60 will open the first keyboard 64 and the touch input unit 90 may show the first keyboard 64 according to the first position information stored in the first storage module 80. If the processing module 60 receives the second detecting signal, the processing module 60 will open the second keyboard 65 and the touch input unit 90 may show the second keyboard 65 according to the second position information stored in the second storage module 70. For example, the first keyboard 64 is shown on the lower left corner of the touch input 90 when the processing module 60 receives the first detecting signal.

When the processing module 60 receives the input command triggered from the first keyboard 64 or the second keyboard 65 on the touch input unit 90, the process module will perform an operation corresponding to the input command. For example, a letter will be deleted when a user touches a “Delete” key.

In the embodiment, the shape of the first and the second keyboards 64 and 65 is approximately like a hand-held fan. An apex of the fan-shaped keyboard is located at a corner of the touch input unit 90 and two edges of the fan-shaped keyboard are aligned along two sides of the corner. Both of the first and the second keyboards 64 and 65 include all of the keys on the traditional soft keyboard, such as 26 English letters a-z, numbers 0-9, a delete key and a space key. As shown in FIG. 2, the first keyboard 64 includes a plurality of keys, such as 15 keys, wherein some of the keys are letter keys; each of the letter keys further represents a plurality of letters. In addition, the keys of the first keyboard 64 and the keys of the second keyboard 65 are distributed with axial symmetry and similar to each other when both of the first and the second keyboard 64 and 65 are shown on the two corners of the touch input unit 90. For example, the English letter keys are shown on the first and the second keyboards 64 and 65 when an input method (IM) key for switching the input method is triggered by the user to switch to English input method. In other words, the user can change keyboard languages or switch the keyboards to number mode when the IM key is triggered.

The position of the first detecting unit 50 on the housing 20 corresponds to the position of the first keyboard 64 on the touch input unit 90 and the position of the second detecting unit 40 on the housing 20 corresponds to the position of the second keyboard 65 on the touch input unit 90. In the embodiment, the first keyboard is preset to show on the lower left corner of the touch input unit 90 and the first detecting unit 50 is installed on the lower left corner of the housing 20. In addition, an apex of the lower left corner of the touch input 90 can overlap an apex of the lower left corner of the housing 20 so that there is no gap between the first keyboard 64 and the housing 20.

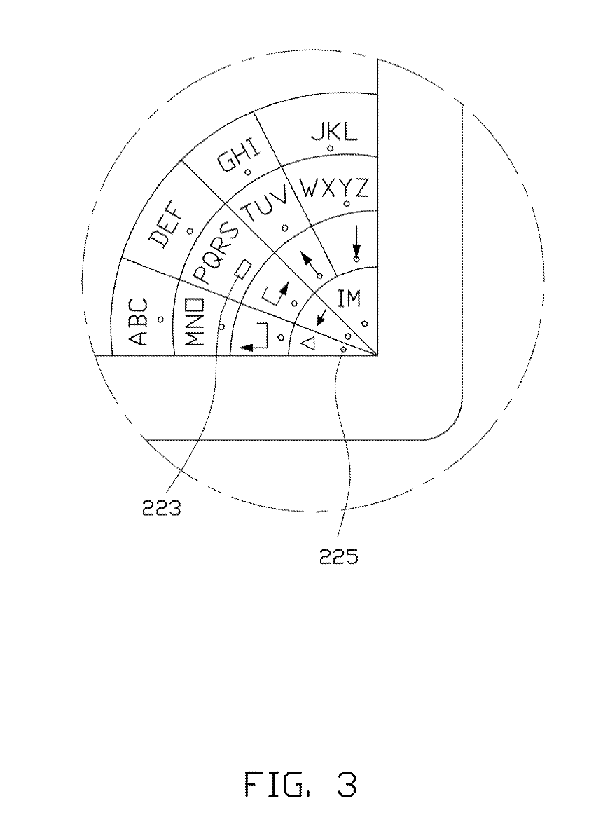

The touch input device 100 further includes two transparent thin films attached on two corners of the touch input unit 90. The shape and the size of the films are the same as those of the first and the second keyboards 64 and 65 so that the films can fully cover the first and the second keyboards 64 and 65. As shown in FIG. 3, the film further includes a plurality of protrusions, wherein the number of the protrusions is the same as that of the keys on the second keyboard 65. In addition, each of the protrusions corresponds to a key on the second keyboard 65 so that it is convenient for the user to locate the positions of the keys. In the embodiment, a protrusion 223 is strip-shaped and the other protrusions 225 are circular shaped. The strip-shape protrusion 223 is located near the center of the second keyboard 65 and its function is similar to the function of the protrusions on the “F” and “J” keys of the conventional keyboard for allowing the users to find the keys without looking.

If the user holds one of the two corners of the housing 20 in one hand, the first detecting unit 50 will detect a touch from the user on the held corner (i.e. the lower left corner) of the housing 20 and transmit the first detecting signal to the processing module 60, for example. Therefore, the processing module 60 opens the first keyboard 64 on the corresponding corner (i.e. the lower left corner) of the touch input unit 90 for one hand operation. Since the user does not hold the other corner (i.e. the lower right corner) of the housing 20, there is no touch detected by the second detecting unit 40. Thus, the processing module does not show the second keyboard 65 on the other corner (i.e. the lower right corner) of the touch input unit. If the user holds the two corners of the touch input unit 90 at the same time, the first and the second keyboards 64 and 65 will show on the two corners so that the user can use his/her two hands to operate. If the user holds the other sites without the detecting unit on the housing 20, the first and the second keyboards 64 and 65 will not show so that the user can use the touch device 100 in full screen view.

In other embodiment, the first and the second detecting units 50 and 40 can be installed on two sides of the frame of the housing 20. The first and the second keyboards 64 and 65 can be shown on two sides of the touch input unit 90, wherein the position of the first keyboard 64 corresponds to that of the first detecting unit 50 and the position of the second keyboard 65 corresponds to that of the second detecting 40. Since the first and the second keyboards 64 and 65 are shown on the two sides of the touch input unit 90, the shape of the first and the second keyboards 64 and 65 can be a semicircle or a rectangle.

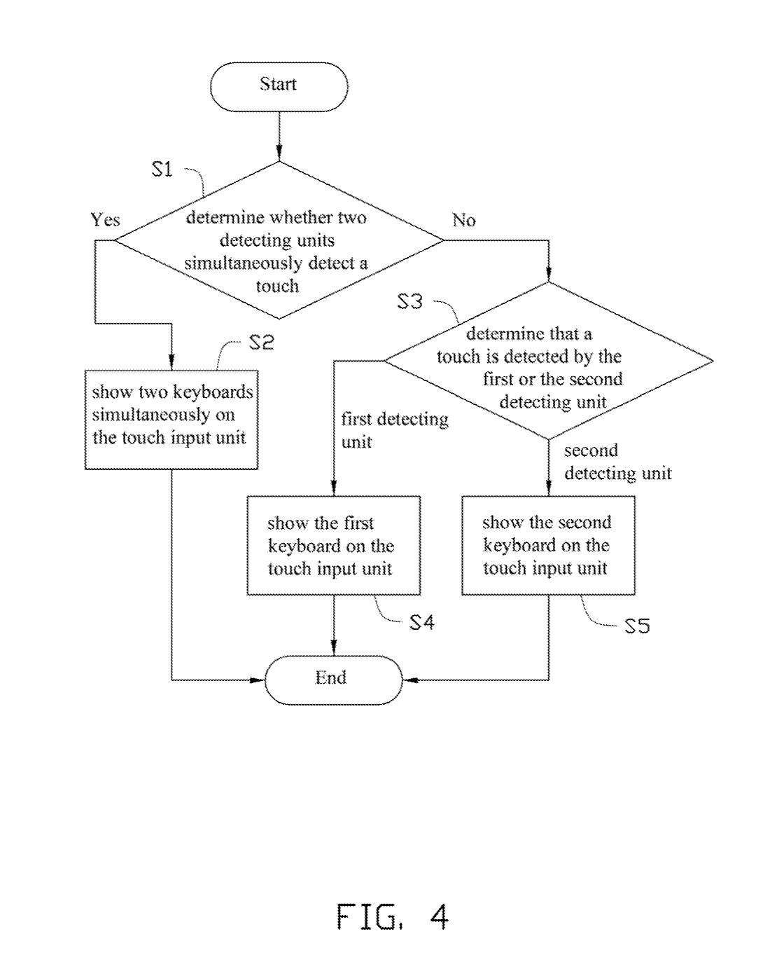

FIG. 4, is an embodiment of a touch input method for using the touch input device 100 as follows:

In step S1, the first detecting unit 50 determines if a touch on the housing 20 occurs. In addition, the second detecting unit 40 simultaneously determines if a touch on the housing 20 occurs. If a touch does occur on the first and the second detecting units 50 and 40 at the same time, the procedure goes to step S2. If the first and the second detecting units 50 and 40 do not detect a touch at the same time, the procedure goes to step S3.

In step S2, the first position information of the first keyboard 64 is read from the first storage medium 80 and the second position information of the second keyboard 65 is read from the second storage medium 70. Then, the first keyboard 64 is shown according to the first position, such as a lower left corner, on the touch input unit 90 and the second keyboard 65 is shown according to the second position, such as a lower right corner, on the touch input unit 90.

In step S3, the first and the second detecting units 50 and 40 determine if a touch occurs on the housing 20. If the first detecting unit 50 detects a touch, the procedure goes to step S4. If the second detecting unit 40 detects a touch, the procedure goes to step S5.

In step S4, the first position information of the first keyboard 64 is read from the first storage medium 80 and then the first keyboard 64 can be shown according to the first position information on the touch input unit 90. However, the second keyboard 65 will not be shown on the touch input unit 90 since there is no touch detected by the second detecting unit 40.

In step S5, the second position information of the second keyboard 65 is read from the second storage medium 70 and then the second keyboard 65 can be shown according to the second position information on the touch input unit 90. However, the first keyboard 64 will not be shown on the touch input unit 90 since there is no touch detected by the first detecting unit 50.

The above touch input device 100 includes two detecting units 50 and 40 installed on two lower corners of the touch input unit. When the user holds one or both of the two lower corners, one or both of the first and the second keyboards will be shown for the user. Therefore, it is convenient for the user to open the keyboard and to use both hands or single hand to input a command. In addition, the keyboards of the disclosure are preset to show on corners of the touch input unit 90. Thus, the area of the screen obstructed by the keyboard is too small to influence the user to operate the touch input device 100.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A touch input device comprising:
a touch input unit configured to show a first keyboard;
a first storage module configured to store the first keyboard and a first position information of the first keyboard on the touch input unit;
a first detecting unit configured near the touch input unit and to transmit a first detecting signal when a touch is detected by the first detecting unit; and
a processing module configured to connect with the first storage module, the touch input unit and the first detecting unit, wherein the first keyboard is shown on the touch input unit according to the first position information when the processing module receives the first detecting signal.

2. The touch input device of claim 1, further comprising:
a second storage module configured to connect with the processing module and to store a second keyboard and a second position information of the second keyboard on the touch input unit; and
a second detecting unit configured near the touch input unit and to transmit a second detecting signal when the touch is detected by the second detecting unit, wherein the second keyboard is shown on the touch input unit according to the second position information when the processing module receives the second detecting signal.

3. The touch input device of claim 2, further comprising:
a housing configured to surround the touch input unit and further comprising at least two corners, wherein the first and the second detecting units are configured on two of the at least two corners.

4. The touch input device of claim 3, wherein the first and the second keyboards are fan-shaped keyboards configured on two corners of the touch input unit, wherein the two corners of the touch input unit are corresponding to the two of the at least two corners of the housing.

5. The touch input device of claim 2, wherein each of the first and the second keyboards further includes a plurality of letter keys, each of the letter keys further represents a plurality of letters.

6. The touch input device of claim 2, wherein the first and the second detecting units are infrared sensors.

7. The touch input device of claim 1, further comprising:
a film configured to cover the first keyboard and comprising a plurality of protrusions, wherein the number of the plurality of protrusions is the same as the number of a plurality of keys on the first keyboard and each of the protrusions corresponds to each of the keys.

8. The touch input device of claim 1, wherein the touch input unit receives a first input command triggered from the first keyboard and the processing module performs the first input command.

9. A touch input method, comprising:
installing a first detecting unit on a housing;
determining whether a touch on the housing is detected by the first detecting unit;
reading a first position of a first keyboard according to a touch position of the touch when the touch is detected by the first detecting unit; and
showing the first keyboard according to the first position.

10. The touch input method of claim 9, further comprising:
installing a second detecting unit on the housing;
determining whether the touch on the housing is detected by the second detecting unit;
reading a second position of a second keyboard according to the touch position of the touch when the touch is detected by the second detecting unit; and
showing the second keyboard according to the second position.

11. The touch input method of claim 10, wherein the first detecting unit is installed on a first corner of the housing, and the second detecting unit is installed on a second corner of the housing.

12. The touch input method of claim 11, further comprising:
determining the touch position by the first and the second detecting units, wherein the touch position corresponds to a position selected from a group consisting of the first corner, the second corners and the combination thereof.

13. The touch input method of claim 11, wherein the first and the second keyboard is shown on a touch input unit, and wherein the first position is a first corner of the touch input unit and the second position is a second corner of the touch input unit.

14. The touch input method of claim 13, wherein the first corner of the touch input unit corresponds to the first corner of the housing, and the second corner of the touch input unit corresponds to the second corner of the housing.

15. A touch input device comprising:
a touch input unit configured to show a soft keyboard; and
a detecting unit configured on a first position of a housing surrounding the touch input unit to determine whether a touch is detected by the detecting unit, wherein the soft keyboard is shown on a second position of the touch input unit corresponding to the first position when the touch is detected by the detecting unit.

16. The touch input device of claim 15, wherein the first position of the housing is a first corner of the housing and the second position of the touch input unit is a second corner of the touch input unit.

17. The touch input device of claim 16, wherein the first corner have a first apex and the second corner have a second apex, and wherein the first apex and the second apex are overlapped with each other.
